(19) United States
(12) Patent Application Publication
(10) Pub. No.: US 2021/0122862 A1
(43) Pub. Date: Apr. 29, 2021

(54) AQUEOUS POLYMER COMPOSITION AND COPOLYMER

(71) Applicant: COATEX, Genay (FR)

(72) Inventors: Clementine CHAMPAGNE, Caluire-et-Cuire (FR); Michel MELAS, Montanay (FR); Laurie PARRENIN, Genay (FR); Jean-Marc SUAU, Lucenay (FR)

(21) Appl. No.: 16/623,430

(22) PCT Filed: Jul. 25, 2018
(86) PCT No.: PCT/FR2018/051901

§ 371 Date: Dec. 17, 2019

(30) Foreign Application Priority Data
Jul. 28, 2017 (FR) 1757232

(51) Int. Cl. C08F 216/14; C08F 2/16; C08F 220/06; C08K 5/38; C04B 24/26

(52) U.S. Cl. CPC C08F 216/1433; C08F 2/16; C04B 2103/12; C08K 5/38; C04B 24/2605; C08F 220/06

(57) ABSTRACT

The invention relates to an aqueous composition comprising a copolymer obtained by a specific polymerisation reaction using an anionic monomer comprising a polymerisable olefinic unsaturation and a carboxylic acid function and a monomer of formula (I):

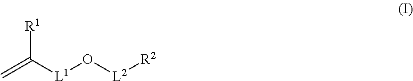

The invention also relates to said copolymer, to a method for the production thereof, and to the use of same as a superplasticizing agent.

The invention relates to an aqueous composition comprising a copolymer obtained by a particular polymerisation reaction using an anionic monomer comprising a polymerisable olefinic unsaturation and a carboxylic acid group and a monomer of formula (I):

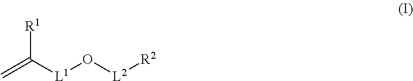

The invention also relates to this copolymer per se, as well as to a method for preparing it and to the use thereof as a superplasticising agent.

The composition according to the invention is advantageously used in the technical field of mortars, concrete, plasters or other compositions based on hydraulic compounds or binders, especially on cement or plaster. Such compositions can be advantageously used in the fields of construction and public works, or in the exploitation of hydrocarbons.

Dispersant compounds of hydraulic binders are typically used for their ability to change the rheology of the medium in which they are present, in particular for their ability to control the workability of this medium.

Workability is usually defined as the property of a composition comprising a hydraulic binder, in particular of a slag or of a cement or mortar slurry, or else of a concrete, for example ready-to-use concrete or precasting concrete, to remain workable for as long as possible. Advantageously, controlling workability makes it possible to transport or move the aqueous composition comprising the hydraulic binder, for example during transport or movement from one tank to another tank. Workability also makes it possible to control the conditions in which such an aqueous composition is stored. It also makes it possible to pump this composition, or to pump it easily. Controlling the workability of such a composition thus makes it possible to improve the conditions of use, in particular to increase its usage time under satisfactory or effective conditions. In general, the workability of an aqueous composition comprising a hydraulic binder can be assessed by measuring the fluidity time of the hydraulic binder. In particular, the hydraulic binder or superplasticising agent should make it possible to obtain a composition with a stable, controlled viscosity and, preferably, a viscosity that is stable over a long period.

Preferably, improving the workability of aqueous hydraulic compositions comprising a hydraulic binder should be possible for compositions comprising a small amount of water.

Thus, an important aspect of the invention lies in the provision of an aqueous composition comprising a hydraulic binder with an improved workability time. Controlling workability should not lead to an alteration of other properties, in particular of mechanical properties, especially at early ages.

The workability of aqueous compositions comprising a hydraulic binder can be assessed by measuring the slump, for example in accordance with standard EN 12350-2. Indeed, slump and workability are proportional.

Slump retention is also a property to be controlled in aqueous compositions comprising a hydraulic binder.

These properties are particularly sought for certain applications, for example when filling formwork with an aqueous composition comprising a hydraulic binder.

Another aspect of the invention relates to obtaining an aqueous composition comprising a hydraulic binder that makes it possible to limit or reduce shrinkage when drying.

Improving the properties of aqueous compositions comprising a hydraulic binder should be achieved without altering the setting of the composition, in particular without delaying the setting.

Aqueous compositions comprising a hydraulic binder should also have the lowest possible weight ratio of water/hydraulic binder, generally water/cement or W/C, without undergoing any alteration of their properties.

One effect that is also sought in aqueous compositions comprising a hydraulic binder is to make it possible to control the amount of entrained air in the material resulting from the setting of the composition, which thus makes it possible to avoid or reduce the presence of anti-foaming agents in the hydraulic composition.

In general, aqueous compositions comprising a hydraulic binder should make it possible to improve the mechanical properties of the materials obtained, in particular their mechanical properties at early ages; these properties can be assessed by measuring the change in the compression strength over time.

In addition, the compounds used in the preparation of aqueous compositions comprising a hydraulic binder should be used in smaller amounts.

They should also be highly or fully compatible with the other components of the aqueous compositions comprising a hydraulic binder, in particular by being miscible in all proportions with these other components, in order to avoid or limit the risks of segregation of the components of the aqueous composition comprising a hydraulic binder.

Increasing the retention time of the properties of the aqueous compositions comprising a hydraulic binder must also be sought.

There are known dispersant compounds or superplasticising agents that can be used in aqueous compositions comprising a hydraulic binder. However, these compounds do not make it possible to provide a solution to the problems encountered. In particular, these compounds do not make it possible to maintain a good initial slump level of the aqueous compositions comprising a hydraulic binder in which they are incorporated, while maintaining their workability and without altering their mechanical properties or triggering segregation phenomena.

Application WO 2016 146935 relates to the use of a particular copolymer to increase the mechanical resistance of a concrete composition. This copolymer is prepared using DMDO, which is a dithiol. Application US 2014 0088250 relates to a method for preparing a polymer using disodic dipropionate trithiocarbonate. Application US 2014 0051801 describes a maleic acid-based comb polymer.

There is therefore a need to have dispersant compounds or superplasticising agents for aqueous compositions comprising a hydraulic binder that make it possible to provide a solution to all or part of the compounds in the prior art.

The invention makes it possible to provide a solution to all or part of the problems encountered with polymeric compositions in the prior art. In particular, the invention makes it possible to obtain copolymers using a particularly effective method of preparation, for example with regard to controlling the temperature of the polymerisation reaction. It is particularly essential to be able to use preparation methods that make it possible to avoid the need for maintaining a low temperature of the reaction medium used during the polymerisation reactions known in the prior art.

Moreover, it is also essential to be able to use preparation methods that make it possible to polymerise unsaturated monomers with different molecular masses M_{W}, for example molecular masses M_{W} ranging from 800 g/mol to 5,000 g/mol measured by SEC, in the presence of comonomers comprising vinyl groups.

Likewise, it is essential to be able to use polymerisation reactions that make it possible to copolymerise monomers with reactivities that limit or impede their polymerisation when using the methods in the prior art.

It is also essential to be able to control these polymerisation reactions, in particular to control the proportions of the polymerised comonomers with respect to the proportions of said comonomers introduced during the reaction. The copolymers prepared can thus comprise comonomer residues in proportions that are identical or similar to the proportions of the monomers used.

Thus, the invention provides an aqueous composition comprising at least one copolymer, the polymolecularity index P_{I} of which is less than 3, obtained by at least one radical polymerisation reaction in water and at a temperature ranging from 10 to 90° C.:
(a) of at least one anionic monomer comprising at least one polymerisable olefinic unsaturation and at least one carboxylic acid group and
(b) of at least one monomer of formula (I):

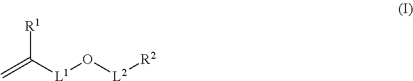

wherein:
   R¹ and R², identical or different, independently represent H or CH₃,
   L¹ independently represents a group chosen among CH₂, CH₂—CH₂ and O—CH₂—CH₂—CH₂—CH₂,
   L² independently represents a group chosen among (CH₂—CH₂O)ₓ, (CH₂CH(CH₃)O)_{y}, (CH(CH₃)CH₂O)_{z} and combinations thereof and
   x, y and z, identical or different, independently represent an integer or decimal comprised between 0 and 150 and the sum of x+y+z is comprised between 10 and 150,
      in the presence:
(i) of from 0.05 to 5% by weight, with respect to the amount of monomers, of at least one compound of formula (II):

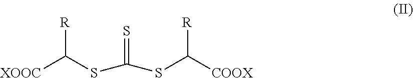

wherein:
   X independently represents H, Na or K and
   R independently represents a C₁-C₅ alkyl group and
(ii) of at least one radical-generating compound chosen among hydrogen peroxide, ammonium persulphate, an alkali metal persulphate, and mixtures or associations thereof with ammonium bisulphite, with an alkali metal bisulphite or with an ion chosen among Fe^{I}, Fe^{III}, Cu^{I}, Cu^{II}.

The conditions for preparing the composition according to the invention are particularly advantageous. Indeed, these conditions for preparing the composition according to the invention make it possible to reduce or avoid the formation of homopolymer of monomer (a). Thus, preferably, the composition according to the invention does not comprise any homopolymer of monomer (a) with respect to the amount by dry weight of copolymer. Also preferably, the composition according to the invention comprises a reduced, small or very small amount by weight of homopolymer of monomer (a) with respect to the amount by dry weight of copolymer. Likewise, the invention makes it possible to avoid or greatly restrict the formation of different copolymers of monomers (a).

According to the invention, the absence or the presence of a reduced, small or very small amount of homopolymer of monomer (a) in the composition according to the invention makes it possible to avoid or limit the risk of inhibiting crystallisation of the concrete when the composition according to the invention is used for its plasticising properties in a concrete formulation. Generally, a homopolymer of monomer (a) has properties that disperse mineral matter particles and can thus disrupt or inhibit crystallisation in a concrete formulation. The properties of the concrete formulation or of the final material prepared using the concrete formulation can thus be changed or altered.

Particularly advantageously and particularly effectively, the invention makes it possible to prepare a copolymer from monomers (a) and (b) while controlling the polymerisation reaction of monomers (a) and (b). The invention thus makes it possible to obtain an aqueous composition comprising a very small amount of residual monomer (a) with respect to the amount by dry weight of copolymer. Preferably, the aqueous composition according to the invention comprises less than 2,000 ppm by weight or less than 1,500 ppm by weight of residual monomer (a) with respect to the amount by dry weight of copolymer. More preferably, the aqueous composition according to the invention comprises less than 1,000 ppm by weight or less than 500 ppm by weight of residual monomer (a) with respect to the amount by dry weight of copolymer. In particular, the aqueous composition according to the invention can comprise less than 200 ppm by weight or less than 100 ppm by weight of residual monomer (a) with respect to the amount by dry weight of copolymer.

The aqueous composition according to the invention comprises at least one copolymer the polymolecularity index P_{I} of which is less than 3. Preferably according to the invention, the polymolecularity index P_{I} ranges from 1.5 to 3, more preferentially from 1.8 to 2.8 or from 1.8 to 2.5, much more preferentially from 2 to 2.8 or from 2 to 2.5.

The copolymer of the aqueous composition according to the invention is obtained by at least one radical polymerisation reaction in water and at a temperature ranging from 10 to 90° C., preferably ranging from 30 to 85° C., more preferentially at a temperature ranging from 40 to 75° C. or from 50 to 70° C. According to the invention, the temperature can also range from 35 to 85° C., from 40 to 85° C., from 45 to 85° C., from 50 to 85° C., from 60 to 85° C. or from 35 to 70° C., from 40 to 70° C., from 45 to 70° C., from 50 to 70° C. or from 60 to 70° C. More preferably, only one radical polymerisation reaction is used.

Preparing the aqueous composition according to the invention uses a radical polymerisation reaction that is carried out in water in the presence of 0.05 to 5% by weight of at least one compound of formula (II) with respect to the amount of monomers. Preferably according to the invention, this compound is of formula (II) wherein R represents a C₁-C₃ alkyl group, preferably a methyl group. The preferred compound of formula (II) according to the invention is disodic dipropionate trithiocarbonate (DPTTC—CAS No. 86470-33-2).

Also preferably according to the invention, the polymerisation reaction uses the compound of formula (II) in an amount ranging from 0.05 to 4% by weight, from 0.05 to 3% by weight, from 0.05 to 2% by weight, from 0.5 to 4% by weight, from 0.5 to 3% by weight, from 0.5 to 2% by weight, from 1 to 4% by weight, from 1 to 3% by weight, from 1 to 2% by weight with respect to the amount of monomers.

Preparing the aqueous composition according to the invention also uses at least one radical-generating compound which is particular. It is preferentially chosen among hydrogen peroxide, ammonium persulphate, sodium persulphate, potassium persulphate, mixtures or associations thereof with sodium bisulphite, with potassium bisulphite or with an ion chosen among Fe^{II}, Fe^{III}, Cu^{I}, Cu^{II}. According to the invention, the Fe^{II}, Fe^{III}, Cu^{I} or Cu^{II} ions can be used by means of at least one compound chosen among iron sulphate, hydrated iron sulphate, iron sulphate hemihydrate, iron sulphate heptahydrate, iron carbonate, hydrated iron carbonate, iron carbonate hemihydrate, iron chloride, copper carbonate, hydrated copper carbonate, copper carbonate hemihydrate, copper acetate, copper sulphate, copper sulphate pentahydrate, copper hydroxide, copper halide.

According to the invention, the particular radical-generating compound is more preferentially chosen among hydrogen peroxide, ammonium persulphate, sodium persulphate, potassium persulphate, in particular sodium persulphate.

According to the invention, the polymerisation reaction is carried out in the absence of any compound comprising phosphorus in the I oxidation state, particularly in the absence of hypophosphorus acid (H₃PO₂) or of a derivative of hypophosphorus acid (H₃PO₂), such as compounds comprising at least one hypophosphite ion (H₂PO₂⁻), in particular in the absence of a compound chosen among sodium hypophosphite (H₂PO₂Na), potassium hypophosphite (H₂PO₂K), calcium hypophosphite ([H₂PO₂]₂Ca).

When preparing the copolymer according to the invention, the amounts of monomers (a) and (b) used can vary greatly. Preferably, the polymerisation reaction uses:
from 1 to 25% by weight of monomer (a) and
from 75 to 99% by weight of monomer (b).

Also preferably, the polymerisation reaction uses:
from 2 to 25% by weight of monomer (a) and
from 75 to 98% by weight of monomer (b).

Also preferably, the polymerisation reaction uses:
from 3 to 15% by weight of monomer (a) and
from 85 to 97% by weight of monomer (b).

Also preferably, the polymerisation reaction uses:
from 3 to 10% by weight of monomer (a) and
from 90 to 97% by weight of monomer (b).

Also preferably, the polymerisation reaction uses:
from 5 to 10% by weight of monomer (a) and
from 90 to 95% by weight of monomer (b).

The invention comprises the use of a radical polymerisation reaction in water of at least one anionic monomer (a) comprising at least one polymerisable olefinic unsaturation and at least one carboxylic acid group or of one of its salts. Preferably, the composition according to the invention comprises a copolymer prepared by a polymerisation reaction using an anionic monomer (a) comprising a polymerisable olefinic unsaturation and a carboxylic acid group or of one of its salts. More preferably, the monomer (a) used is chosen among acrylic acid, methacrylic acid, itaconic acid, maleic acid, an acrylic acid salt, a methacrylic acid salt, an itaconic acid salt, a maleic acid salt and mixtures thereof. Even more preferably, the monomer (a) used is chosen among acrylic acid, methacrylic acid, an acrylic acid salt, a methacrylic acid salt and mixtures thereof, more particularly acrylic acid or an acrylic acid salt, in particular a sodium salt of acrylic acid.

During the radical polymerisation reaction in water, the invention also comprises the use of at least one monomer (b) of formula (I).

Preferably according to the invention, the compound (b) is a compound (b1) of formula (I) wherein:
R¹ and R² represent H,
L¹ represents a CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b2) of formula (I) wherein:
R¹ represents H,
R² represents CH₃,
L¹ represent a CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b3) of formula (I) wherein:
R¹ represents CH₃,
R² represents H,
L¹ represents a CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b4) of formula (I) wherein:
R¹ and R² represent CH₃,
L¹ represents a CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b5) of formula (I) wherein:
R¹ and R² represent H,
L¹ represents a CH₂—CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b6) of formula (I) wherein:
R¹ represents H,
R² represents CH₃,
L¹ represents a CH₂—CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b7) of formula (I) wherein:
R¹ represents CH₃,
R² represents H,
L¹ represents a CH₂—CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b8) of formula (I) wherein:
R¹ and R² represent CH₃,
L¹ represents a CH₂—CH₂ group,
L² represents a group combining (CH₂—CH₂O)ₓ and (CH₂CH(CH₃)O)_{y} or (CH(CH₃)CH₂)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b9) of formula (I) wherein:
R¹ and R² represent H,
L¹ represents an O—CH₂—CH₂—CH₂—CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b10) of formula (I) wherein:
R¹ represents H,
R² represents CH₃,
L¹ represents an O—CH₂—CH₂—CH₂—CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b11) of formula (I) wherein:
R¹ represents CH₃,
R² represents H,
L¹ represents an O—CH₂—CH₂—CH₂—CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b12) of formula (I) wherein:
R¹ and R² represent CH₃,
L¹ represents an O—CH₂—CH₂—CH₂—CH₂ group,
L² represents a group combining (CH₂—CH₂O)ₓ and (CH₂CH(CH₃)O)_{y} or (CH(CH₃)CH₂O)_{z},
x represents an integer or decimal comprised between 10 and 140,
y+z represents an integer or decimal comprised between 10 and 140 and
x is strictly greater than y+z and the sum of x+y+z is comprised between 10 and 150.

Preferably according to the invention, the compound (b) is a compound (b13) of formula (I) wherein:
R¹ and R² represent H,
L¹ represents a CH₂ group,
L² represents a (CH₂—CH₂O)ₓ group and
x represents an integer or decimal comprised between 10 and 140.

Preferably according to the invention, the compound (b) is a compound (b14) of formula (I) wherein:
R¹ represents H,
R² represents CH₃,
L¹ represents a CH₂ group,
L² represents a (CH₂—CH₂O)ₓ group and
x represents an integer or decimal comprised between 10 and 140.

Preferably according to the invention, the compound (b) is a compound (b15) of formula (I) wherein:
R¹ represents CH₃,
R² represents H,
L¹ represents a CH₂ group,
L² represents a (CH₂—CH₂O)ₓ group and
x represents an integer or decimal comprised between 10 and 140.

Preferably according to the invention, the compound (b) is a compound (b16) of formula (I) wherein:
R¹ and R² represent CH₃,
L¹ represents a CH₂ group,
L² represents a (CH₂—CH₂O)ₓ group and
x represents an integer or decimal comprised between 10 and 140.

Preferably according to the invention, the compound (b) is a compound (b17) of formula (I) wherein:
R¹ and R² represent H,
L¹ represents a CH₂—CH₂ group,
L² represents a (CH₂—CH₂O)ₓ group and
x represents an integer or decimal comprised between 10 and 140.

Preferably according to the invention, the compound (b) is a compound (b18) of formula (I) wherein:
R¹ represents H,
R² represents CH₃,
L¹ represents a CH₂—CH₂ group,
L² represents a (CH₂—CH₂O)ₓ group and
x represents an integer or decimal comprised between 10 and 140.

Preferably according to the invention, the compound (b) is a compound (b19) of formula (I) wherein:
R¹ represents CH₃,
R² represents H,
L¹ represents a CH₂—CH₂ group,
L² represents a (CH₂—CH₂O)ₓ group and
x represents an integer or decimal comprised between 10 and 140.

Preferably according to the invention, the compound (b) is a compound (b20) of formula (I) wherein:
R¹ and R² represent CH₃,
L¹ represents a CH₂—CH₂ group,
L² represents a (CH₂—CH₂O)ₓ group and
x represents an integer or decimal comprised between 10 and 140.

Preferably according to the invention, the compound (b) is a compound (b21) of formula (I) wherein:
R¹ and R² represent H,
L¹ represents an O—CH₂—CH₂—CH₂—CH₂ group,
L² represents a (CH₂—CH₂O) group and
x represents an integer or decimal comprised between 10 and 140.

Preferably according to the invention, the compound (b) is a compound (b22) of formula (I) wherein:
R¹ represents H,
R² represents CH₃,
L¹ represents an O—CH₂—CH₂—CH₂—CH₂ group,
L² represents a (CH₂—CH₂O)ₓ group and
x represents an integer or decimal comprised between 10 and 140.

Preferably according to the invention, the compound (b) is a compound (b23) of formula (I) wherein:
R¹ represents CH₃,
R² represents H,
L¹ represents an O—CH₂—CH₂—CH₂—CH₂ group,
L² represents a (CH₂—CH₂O) group and
x represents an integer or decimal comprised between 10 and 140.

Preferably according to the invention, the compound (b) is a compound (b24) of formula (I) wherein:
R¹ and R² represent CH₃,
L¹ represents an O—CH₂—CH₂—CH₂—CH₂ group,
L² represents a (CH₂—CH₂O)ₓ group and
x represents an integer or decimal comprised between 10 and 140.

Preferably, the compound (b) of formula (I) is a compound wherein:
x represents an integer or decimal comprised between 15 and 140,
y+z represents an integer or decimal comprised between 10 and 135 and
x is strictly greater than y+z and the sum of x+y+z is comprised between 10 and 150.

More preferably, the compound (b) is a compound of formula (I) wherein x represents an integer or decimal comprised between 10 and 150 or from 30 to 120, y+z represents an integer or decimal comprised between 10 and 135, x is strictly greater than y+z and the sum of x+y+z is comprised between 10 and 150.

Also more preferably, the compound (b) is a compound of formula (I) wherein x represents an integer or decimal comprised between 20 and 130 or from 30 to 120, and y and z represent 0.

Also more preferably, the compound (b) is a compound of formula (I) wherein x represents an integer or decimal comprised between 15 and 80 and y+z represents an integer or decimal comprised between 10 and 65, preferably a compound of formula (I) wherein x represents an integer or decimal comprised between 30 and 65 and y+z represents an integer or decimal comprised between 15 and 40, in particular a compound of formula (I) wherein x represents an integer or decimal comprised between 40 and 60 and y+z represents an integer or decimal comprised between 20 and 30, for example a compound of formula (I) wherein x represents 50 and y represents 25.

Also more preferably, the monomer (b) is a compound of formula (I) wherein x is strictly greater than y+z.

According to the invention, a preferred compound (b) is a compound chosen among the compounds (b1), (b3), (b15), (b19) and (b21).

The aqueous composition according to the invention comprises at least one copolymer obtained by means of at least one radical polymerisation reaction in water of at least one monomer (a) and of at least one monomer (b) of formula (I). The polymerisation reaction can also use one or several other monomer(s). The radical polymerisation reaction can then also use at least one other monomer (c) chosen among:
another anionic monomer, preferably chosen among acrylic acid, methacrylic acid, itaconic acid, maleic acid, their salts and mixtures thereof.
a non-ionic monomer comprising at least one polymerisable olefinic unsaturation, preferably at least one polymerisable ethylenic unsaturation and in particular a polymerisable vinyl group, more preferentially a non-ionic monomer chosen among the esters of an acid comprising at least one monocarboxylic acid group, in particular an ester of an acid chosen among acrylic acid, methacrylic acid and mixtures thereof, for example hydroxyethyl acrylate, hydroxypropyl acrylate, hydroxyethyl methacrylate, hydroxypropyl methacrylate, styrene, vinyl caprolactam, alkyl acrylate, in particular C₁-C₁₀-alkyl acrylate, preferentially C₁-C₄-alkyl acrylate, more preferentially methyl acrylate, ethyl acrylate, propyl acrylate, isobutyl acrylate, n-butyl acrylate, alkyl methacrylate, in particular C₁-C₁₀-alkyl methacrylate, preferentially C₁-C₄-alkyl methacrylate, more preferentially methyl methacrylate, ethyl methacrylate, propyl methacrylate, isobutyl methacrylate, n-butyl methacrylate, aryl acrylate, preferably phenyl acrylate, benzyl acrylate, phenoxyethyl acrylate, aryl methacrylate, preferably phenyl methacrylate, benzyl methacrylate, phenoxyethyl methacrylate, a compound of formula (III):

Q¹-(L¹)ₘ-(L²)ₙ-Q² (III)
wherein:
   Q¹ represents a polymerisable acrylate group or a polymerisable methacrylate group,
   Q² represents an H group or a CH₃ group,
   L¹ and L², identical or different, independently represent an ethylene-oxy group or a propylene-oxy group and
   m and n, identical or different and of which at least one is different to 0, represent a number less than or equal to 150 and their sum m+n is less than 150 and
2-acrylamido-2-methylpropanesulphonic acid, a salt of 2-acrylamido-2-methylpropanesulphonic acid, 2-(methacryloyloxy)ethanesulphonic acid, a salt of 2-(methacryloyloxy)ethanesulphonic acid, sodium methallyl sulphonate, styrene sulphonate and mixtures thereof.

Advantageously, the aqueous composition according to the invention comprises at least one copolymer obtained by at least one radical polymerisation reaction in water that is carried out in the absence of maleic acid or in the absence of maleic anhydride.

The invention provides an aqueous composition comprising at least one copolymer obtained by at least one radical polymerisation reaction in water of at least one anionic monomer (a) comprising at least one polymerisable olefinic unsaturation and at least one carboxylic acid group or one of its salts and of at least one monomer (b) of formula (I). The invention also relates to such a copolymer per se, in particular such a copolymer obtained from an aqueous composition according to the invention then separation of the copolymer according to the invention, in particular separation of the water from the aqueous composition according to the invention.

The invention thus provides a copolymer, the polymolecularity index P_{I} of which is less than 3, obtained by at least one radical polymerisation reaction in water and at a temperature ranging from 10 to 90° C.:
(a) of at least one anionic monomer comprising at least one polymerisable olefinic unsaturation and at least one carboxylic acid group and
(b) of at least one monomer of formula (I):

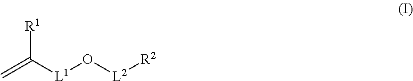

wherein:
   R¹ and R², identical or different, independently represent H or CH₃,
   L¹ independently represents a group chosen among CH₂, CH₂—CH₂ and O—CH₂—CH₂—CH₂—CH₂,
   L² independently represents a group chosen among (CH₂—CH₂O)ₓ, (CH₂CH(CH₃)O)_{y}, (CH(CH₃)CH₂O)_{z} and combinations thereof and
   x, y and z, identical or different, independently represent an integer or decimal comprised between 0 and 150, preferably x is strictly greater than y+z and the sum of x+y+z is comprised between 10 and 150, in the presence:
(i) of from 0.05 to 5% by weight, with respect to the amount of monomers, of at least one compound of formula (II):

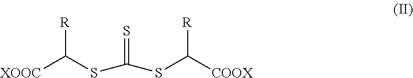

wherein:
   X independently represents H, Na or K and
   R independently represents a C₁-C₅ alkyl group and
(ii) of at least one radical-generating compound chosen among hydrogen peroxide, ammonium persulphate, an alkali metal persulphate, and mixtures or associations thereof with ammonium bisulphite, with an alkali metal bisulphite or with an ion chosen among Fe^{II}, Fe^{III}, Cu^{I}, Cu^{II}.

Preferably, the copolymer according to the invention comprises:
from 1 to 25% by weight of monomer (a) and
from 75 to 99% by weight of monomer (b).

Also preferably, the copolymer according to the invention comprises:
from 2 to 25% by weight of monomer (a) and
from 75 to 98% by weight of monomer (b).

Also preferably, the copolymer according to the invention comprises:
from 3 to 15% by weight of monomer (a) and
from 85 to 97% by weight of monomer (b).

Also preferably, the copolymer according to the invention comprises:
from 3 to 10% by weight of monomer (a) and
from 90 to 97% by weight of monomer (b).

Also preferably, the copolymer according to the invention comprises:
from 5 to 10% by weight of monomer (a) and
from 90 to 95% by weight of monomer (b).

The copolymer according to the invention can also be characterised by its molecular mass by weight (M_{W}). Preferably, it has a molecular mass by weight ranging from 8,000 g/mol to 600,000 g/mol or from 10,000 g/mol to 500,000 g/mol or else from 12,000 g/mol to 200,000 g/mol. More preferably, it has a molecular mass by weight ranging from 15,000 g/mol to 150,000 g/mol or from 15,000 g/mol to 90,000 g/mol or else from 15,000 g/mol to 90,000 g/mol or from 25,000 g/mol to 75,000 g/mol.

According to the invention, the molecular weight and polymolecularity index of the copolymers are determined by Steric Exclusion Chromatography (SEC). This technique uses a Waters liquid chromatography apparatus equipped with a detector. This detector is a Waters refractive index detector. This liquid chromatography apparatus is equipped with a steric exclusion column in order to separate the various molecular weights of the copolymers studied. The liquid elution phase is an aqueous phase adjusted to pH 9.00 using 1N sodium hydroxide containing 0.05 M of NaHCO₃, 0.1 M of NaNO₃, 0.02 M of triethanolamine and 0.03% of NaN₃.

According to a first step, the copolymer solution is diluted to 0.9% by dry weight in the solubilisation solvent of the SEC, which corresponds to the liquid elution phase of the SEC to which 0.04% of dimethyl formamide is added, which acts as a flow rate marker or internal standard. Then it is filtered using a 0.2 μm filter. Then 100 μL are injected into the chromatography apparatus (eluent: an aqueous phase adjusted to pH 9.00 by 1N sodium hydroxide containing 0.05 M of NaHCO₃, 0.1 M of NaNO₃, 0.02 M of triethanolamine and 0.03% of NaN₃).

The liquid chromatography apparatus has an isocratic pump (Waters 515) the flow rate of which is set to 0.8 mL/min. The chromatography apparatus also comprises an oven which itself comprises the following system of columns in series: a Waters Ultrahydrogel Column Guard precolumn 6 cm long and 40 mm in inner diameter, and a Waters Ultrahydrogel linear column 30 cm long and 7.8 mm in inner diameter. The detection system is comprised of a Waters 410 RI refractive index detector. The oven is heated to 60° C. and the refractometer is heated to 45° C.

Molecular masses are assessed by detection of the dynamic light scattering using a Viscotek 270 dual detector to determine the molecular mass based on the hydrodynamic volume of the copolymer.

The particular, advantageous or preferred characteristics of the aqueous composition according to the invention define copolymers according to the invention, which are also particular, advantageous or preferred.

The aqueous composition and the copolymer according to the invention have properties that are particularly advantageous in many technical fields. Thus, according to the technical field in which these properties are used, the aqueous composition or the copolymer according to the invention can have different forms. They can in particular be used in various formulations.

The invention thus provides a formulation (F1) comprising:
at least one aqueous composition according to the invention,
at least one hydraulic binder, optionally
water, optionally
at least one aggregate, optionally
at least one admixture.

The invention also provides a formulation (F2) comprising:
at least one copolymer according to the invention,
at least one hydraulic binder, optionally
water, optionally
at least one aggregate, optionally
at least one admixture.

Preferably, formulations (F1) and (F2) according to the invention comprise:
from 0.01 to 5% by dry weight of copolymer, respectively in the form of at least one aqueous composition according to the invention or of at least one copolymer according to the invention, per se, and
from 95 to 99.9% by dry weight of at least one hydraulic binder.

More preferably, formulations (F1) and (F2) according to the invention comprise:
from 0.01 to 4% by dry weight or from 0.01 to 3% by dry weight of copolymer, respectively in the form of at least one aqueous composition according to the invention or of at least one copolymer according to the invention, per se, and
from 96 to 99.9% by dry weight or from 97 to 99.9% by dry weight of at least one hydraulic binder.

Also more preferably, formulations (F1) and (F2) according to the invention comprise:
from 0.03 to 5% by dry weight or from 0.03 to 4% by dry weight or from 0.03 to 3% by dry weight of copolymer, respectively, in the form of at least one aqueous composition according to the invention or of at least one copolymer according to the invention, per se, and
from 95 to 99.7% by dry weight or from 96 to 99.7% by dry weight or from 97 to 99.7% by dry weight of at least one hydraulic binder.

Also more preferably, formulations (F1) and (F2) according to the invention comprise:
from 0.05 to 5% by dry weight or from 0.05 to 4% by dry weight or from 0.05 to 3% by dry weight or from 0.05% to 2% by dry weight or from 0.05 to 1.5% by dry weight of copolymer, respectively in the form of at least one aqueous composition according to the invention or of at least one copolymer according to the invention, per se, and
from 95 to 99.5% by dry weight or from 96 to 99.5% by dry weight or from 97 to 99.5% by dry weight or from 98 to 99.5% by dry weight or from 98.5 to 99.5% by dry weight of at least one hydraulic binder.

Also preferably, formulations (F1) and (F2) according to the invention comprise water in an amount by weight, with respect to the amount by weight of the hydraulic binder, of less than 0.7, less than 0.65 or less than 0.6, preferably less than 0.5 or less than 0.4, or else less than 0.3 or less than 0.2. The amount by weight of water with respect to the amount by weight of hydraulic binder in formulations (F1) and (F2) preferably ranges from 0.2 to 0.65 or from 0.2 to 0.6 or from 0.2 to 0.5 or from 0.3 to 0.65 or from 0.3 to 0.6 or from 0.3 to 0.5.

According to the invention, the hydraulic binder or hydrolith can be chosen among cement, mortar, plaster, slurry or concrete.

The cement can be chosen among Portland cement, white Portland cement, artificial cement, blast furnace cement, high strength cement, aluminate cement, quick-setting cement, magnesium phosphate cement, cement based on incineration products, fly ash cement and mixtures thereof.

Other hydraulic binders can be chosen among latent hydraulic binders, pozzolanic binders, ash, slag, clinker.

The plaster can be chosen among gypsum, calcium sulphate dihydrate, calcium sulphate, calcium sulphate hemihydrate, calcium sulphate anhydride and mixtures thereof.

The aggregate can be chosen among sand, coarse aggregate, gravel, crushed stone, slag, recycled aggregate.

Generally, according to their particle size, granulates are classified in several known categories as such by the person skilled in the art, for example according to French standard XP P 18-540. According to this standard, which notably defines the d and D values, the granulate families comprise:
0/D fillers for which D<2 mm with at least 70% passing at 0.063 mm,
0/D fine-grain sands for which D≤1 mm with less than 70% passing at 0.063 mm,
0/D sand for which 1<D≤6.3 mm,
0/D gravel-sand mixtures for which D>6.3 mm,
d/D chipping for which d>1 mm and D≤125 mm and
d/D ballast for which d>25 mm and D≤50 mm.

Examples of fillers are silica fume or siliceous additions, or calcareous additions such as calcium carbonate.

According to the invention, the admixture in formulations (F1) or (F2) can be chosen among an anti-foaming agent, a plasticising or superplasticising agent, a workability-enhancing agent, a slump-reducing agent, an agent for reducing trapped air, a colouring agent, a pigment, a water-reducing agent, a setting retarder, a hygroscopicity control agent, an anti-corrosion agent, an anti-shrink agent, a silico-alkaline-reaction-inhibiting agent, a water-repellent agent, a foaming agent.

The particular properties of the aqueous composition according to the invention or of the copolymer according to the invention make it possible to use them in many technical fields, in particular for their rheology regulation or control properties.

Thus, the invention provides a method for changing the rheology of a hydraulic formulation comprising the addition of at least one aqueous composition according to the invention or of at least one copolymer according to the invention in the hydraulic formulation comprising water and a hydraulic binder.

The properties of the composition according to the invention and of the copolymer are particularly useful in the field of hydraulic formulations.

Thus, the invention provides a method for controlling the workability of a hydraulic formulation comprising the addition of at least one aqueous composition according to the invention or of at least one copolymer according to the invention in a hydraulic formulation. Particularly advantageously, the invention provides a method for controlling workability wherein the workability of the hydraulic formulation is kept constant for at least 1 hour, preferably for at least 2 hours, more preferentially for at least 3 hours, even more preferentially for at least 3.5 hours or at least 4 hours.

The invention also provides a method for reducing the setting time of a hydraulic formulation comprising the addition of at least one aqueous composition according to the invention or of at least one copolymer according to the invention in a hydraulic formulation comprising water and a hydraulic binder.

In methods for controlling the workability of a hydraulic formulation or reducing the setting time of a hydraulic formulation according to the invention, the hydraulic formulation is preferably chosen among a hydraulic formulation (F1) and a hydraulic formulation (F2).

The particular, advantageous or preferred characteristics of the hydraulic formulations (F1) and (F2) according to the invention define the methods for controlling the workability of a hydraulic formulation or for reducing the setting time of a hydraulic formulation according to the invention, which are also particular, advantageous or preferred.

The following examples illustrate the various aspects of the invention.

### EXAMPLES

### Example 1: Preparation of Copolymers According to the Invention and of a Comparative Copolymer

### Example 1.1: Copolymer (P1) According to the Invention

Water (50 g), iron sulphate heptahydrate (0.11 g), a 60% by mass solution in water (271.92 g) of monomer (b15) with a molecular mass of 2,400 g/mol, a comonomer (maleic anhydride) (9.71 g), a 50% by mass aqueous solution of sodium hydroxide (15.35 g) and a 20% by mass solution in water (2.68 g) of DPTTC are placed in a stirred reactor. The reactor is heated to 58±3° C. Hydrogen peroxide is added in a 35% by mass aqueous solution (5.6 g).

Then, for 2 hours, a mixture of water (30 g) and of acrylic acid (22.65 g), a mixture of water (25 g), of a 60% by mass solution in water (32.7 g) of a monomer (b15) with a molecular mass of 2,400 g/mol and of a 20% by mass solution in water (10.0 g) of DPTTC are simultaneously injected into the reactor, along with a mixture of water (55 g) and a 40% by mass aqueous solution of sodium bisulphite (5.64 g), with this latter mixture injected in 2 hours and 15 minutes.

The reactor is kept at a temperature of 58±3° C. for 1 hour.

The product is cooled and then partially neutralised by adding a 50% by mass aqueous solution of sodium hydroxide (22.3 g). The aqueous polymeric solution comprises less than 900 ppm of residual dry acrylic acid with respect to the total amount of dry copolymer.

A copolymer (P1) is obtained comprising 10.5% by weight of acrylic acid, 85.0% by weight of monomer (b15) and 4.5% by weight of maleic anhydride. It has a molecular mass M_{W} of 51,000 g/mol and a polymolecularity index P of 1.9.

### Example 1.2: Copolymer (P2) According to the Invention

Water (50 g), iron sulphate heptahydrate (0.11 g), a 60% by mass solution in water (271.92 g) of a monomer (b15) with a molecular mass of 2,400 g/mol and a 20% by mass solution in water (2.54 g) of DPTTC are placed in a stirred reactor. The reactor is heated to 35±2° C. Hydrogen peroxide is added in a 35% by mass aqueous solution (5.6 g). Then, for 1 hour and 15 minutes, a mixture of water (30 g) and of acrylic acid (32.26 g) and a mixture of a 60% by mass solution in water (32.7 g) of monomer (b15) with a molecular mass of 2,400 g/mol, of water (30 g) and of a 20% by mass solution in water (10.15 g) of DPTTC are simultaneously injected into the reactor, along with a mixture of water (55 g) and sodium bisulphite (5.64 g), with this latter mixture injected in 1 hour and 40 minutes.

The reactor is kept at a temperature of 35±2° C. for 1 hour and 30 minutes. The product is cooled and then partially neutralised by adding a 50% by mass aqueous solution of sodium hydroxide (36 g). The aqueous polymeric solution comprises less than 1,430 ppm of residual dry acrylic acid with respect to the total amount of dry copolymer. A copolymer (P2) is obtained comprising 14.5% by weight of acrylic acid and 85.5% by weight of monomer (b15). It has a molecular mass M_{W} of 129,800 g/mol and a polymolecularity index P₁ of 2.0.

### Example 1.3: Copolymer (P3) According to the Invention

Water (50 g), iron sulphate heptahydrate (0.11 g), a 60% by mass solution in water (264.56 g) of a monomer (b15) with a molecular mass of 2,400 g/mol and a 20% by mass solution in water (2.54 g) of DPTTC are placed in a stirred reactor. The reactor is heated to 55±2° C. Hydrogen peroxide is added in an aqueous solution at 35% by mass (5.6 g). Then, for 1 hour and 15 minutes, a mixture of water (30 g) and of acrylic acid (32.49 g) and a mixture of a 60% by mass solution in water (32.7 g) of monomer (b15) with a molecular mass of 2,400 g/mol, a mixture of water (16 g) and of a 20% by mass solution in water (10.15 g) of DPTTC are simultaneously injected into the reactor along with a mixture of water (55 g) and ammonium persulphate (2.26 g), with this latter mixture injected in 1 hour and 40 minutes.

The reactor is kept at a temperature of 55±2° C. for 1 hour and 30 minutes.

The product is cooled and then partially neutralised by adding a 50% by mass aqueous solution of sodium hydroxide (34.8 g). The aqueous polymeric solution comprises less than 130 ppm of residual dry acrylic acid with respect to the total amount of dry copolymer.

A copolymer (P3) is obtained comprising 15.4% by weight of acrylic acid and 84.6% by weight of monomer (b15). It has a molecular mass M_{W} of 54,200 g/mol and a polymolecularity index P_{I} of 1.7.

### Example 1.4: Copolymer (P4) According to the Invention

Water (240 g) and a 20% by mass solution in water (3.0 g) of DPTTC are placed in a stirred reactor. The reactor is heated to 65±2° C.

Then, for 3 hours, a mixture of water (10 g), of acrylic acid (22.88 g) and of a 60% by mass solution in water (782.52 g) of monomer (b15) with a molecular mass of 2,400 g/mol, a mixture of water (40 g) and of a 20% by mass solution in water (12.0 g) of DPTTC are simultaneously injected into the reactor along with a mixture of water (65 g) and ammonium persulphate (6.09 g).

The reactor is kept at a temperature of 65±2° C. for 1 hour.

The product is cooled and then partially neutralised by adding a 50% by mass aqueous solution of sodium hydroxide (1.3 g). The aqueous polymeric solution comprises less than 40 ppm of residual dry acrylic acid with respect to the total amount of dry copolymer.

A copolymer (P4) is obtained comprising 4.6% by weight of acrylic acid and 95.4% by weight of monomer (b15). It has a molecular mass M_{W} of 55,100 g/mol and a polymolecularity index ₚI of 1.4.

### Example 1.5: Copolymer (P5) According to the Invention

Water (10 g), iron sulphate heptahydrate (0.11 g), a 60% by mass solution in water (318 g) of a monomer (b3) of formula (I) wherein L² represents a combination (CH₂—CH₂O)ₓ, (CH₂CH(CH₃)O)_{y} and (CH(CH₃)CH₂O)_{z}, x represents 42 and y+z represents 15.5, with a molecular mass of 3,000 g/mol, and a 20% by mass solution in water (2.03 g) of DPTTC, are placed in a stirred reactor. The reactor is heated to 58±3° C.

Hydrogen peroxide is added in a 35% by mass aqueous solution (4.48 g).

Then, for 2 hours, a mixture of water (50 g) and of acrylic acid (20.14 g), a mixture of a 20% by mass solution of DPTTC (8.12 g) and water (40 g) and a mixture of water (55 g) and of a 40% by mass aqueous solution of sodium bisulphite (4.51 g) are simultaneously injected into the reactor, with this latter mixture injected in 2 hours and 15 minutes.

The reactor is then kept at a temperature of 58±3° C. for 1 hour.

The product is cooled and then partially neutralised by adding a 50% by mass aqueous solution of sodium hydroxide until pH 7.5 is reached. The aqueous polymeric solution comprises less than 1,500 ppm of residual dry acrylic acid with respect to the total amount of dry copolymer.

A copolymer (P5) is obtained with a molecular mass by weight of 60,820 g/mol and a polymolecularity index P_{I} of 1.2.

### Example 1.6: Copolymer (P6) According to the Invention

Water (10 g), iron sulphate heptahydrate (0.11 g), a 60% by mass solution in water (318 g) of a monomer (b3) of formula (I) wherein L² represents a combination (CH₂—CH₂O)ₓ, (CH₂CH(CH₃)O)_{y} and (CH(CH₃)CH₂O)_{z}, x represents 52 and y+z represents 11, with a molecular mass of 3,000 g/mol, and a 20% by mass solution in water (2.03 g) of DPTTC, are placed in a stirred reactor. The reactor is heated to 58±3° C.

Hydrogen peroxide is added in a 35% by mass aqueous solution (4.48 g).

Then, for 2 hours, a mixture of water (50 g) and of acrylic acid (20.14 g), a mixture of a 20% by mass solution of DPTTC (8.12 g) and water (40 g), and a mixture of water (50 g) and 40% by mass aqueous solution of sodium bisulphite (4.51 g) are simultaneously injected into the reactor, with this latter mixture injected in 2 hours and 15 minutes.

The reactor is then kept at a temperature of 58±3° C. for 1 hour.

The product is cooled and then partially neutralised by adding a 50% by mass aqueous solution of sodium hydroxide until pH 7.5 is reached. The aqueous polymeric solution comprises less than 910 ppm of residual dry acrylic acid with respect to the total amount of dry copolymer.

A copolymer (P6) is obtained with a molecular mass by weight of 46,190 g/mol and a polymolecularity index P_{I} of 1.3.

### Example 1.7: Copolymer (P7) According to the Invention

Water (145 g), iron sulphate heptahydrate (0.11 g), a monomer (b19) with a molecular mass of 2,400 g/mol (191 g), and a 20% by mass solution in water (2.54 g) of DPTTC are placed in a stirred reactor. The reactor is heated to 58±3° C.

Hydrogen peroxide is added in a 35% by mass aqueous solution (5.6 g).

Then, for 2 hours, a mixture of water (30 g) and of acrylic acid (20.14 g), a mixture of a 20% by mass solution of DPTTC (10.2 g) and of water (55 g) are simultaneously injected into the reactor along with a mixture of water (55 g) and ammonium persuplhate (2.6 g).

The reactor is then kept at a temperature of 58±3° C. for 1 hour.

The product is cooled and then partially neutralised by adding a 50% by mass aqueous solution of sodium hydroxide until pH 7.3 is reached. The aqueous polymeric solution comprises less than 25 ppm of residual dry acrylic acid with respect to the total amount of dry copolymer.

A copolymer (P7) is obtained with a molecular mass by weight of 62,700 g/mol and a polymolecularity index P_{I} of 2.2.

### Example 1.8: Copolymer (P8) According to the Invention

Water (10 g), iron sulphate heptahydrate (0.11 g), a 60% by mass solution in water (318 g) of a monomer (b3) of formula (I) wherein R¹ represents CH₃, R² represents H, L¹ represents CH₂, L² represents a combination (CH₂—CH₂O)ₓ, (CH₂CH(CH₃)O)_{y} and (CH(CH₃)CH₂O)_{z}, x represents 42 and y+z represents 15.5, with a molecular mass of 3,000 g/mol, and a 20% by mass solution in water (2.54 g) of DPTTC, are placed in a stirred reactor. The reactor is heated to 65±3° C.

Hydrogen peroxide is added in a 35% by mass aqueous solution (5.6 g).

Then, for 2 hours, a mixture of water (50 g) and of acrylic acid (20.14 g), a mixture of a 20% by mass solution of DPTTC (10.15 g) and of water (40 g) are simultaneously injected into the reactor along with a mixture of water (55 g) and ammonium persuplhate (2.26 g).

The reactor is kept at a temperature of 65±1° C. for 1 hour.

The product is cooled and then partially neutralised by adding a 50% by mass aqueous solution of sodium hydroxide until pH 7.2 is reached. The aqueous polymeric solution comprises less than 810 ppm of residual dry acrylic acid with respect to the total amount of dry copolymer.

A copolymer (P8) is obtained with a molecular mass by weight of 51,600 g/mol and a polymolecularity index P_{I} of 1.3.

### Example 1.9: Copolymer (P9) According to the Invention

Water (160 g), iron sulphate heptahydrate (0.11 g), a monomer (b19) with a molecular mass of 2,400 g/mol (194.6 g), and a 20% by mass solution in water (2.03 g) of DPTTC are placed in a stirred reactor. The reactor is heated to 65±1° C.

Hydrogen peroxide is added in a 35% by mass aqueous solution (4.48 g).

Then, for 2 hours, a mixture of water (30 g) and of acrylic acid (20.55 g), a mixture of a 20% by mass solution of DPTTC (8.12 g) and of water (50 g) and a mixture of water (55 g) and a 40% by mass solution of sodium bisulfite are simultaneously injected into the reactor.

The reactor is kept at a temperature of 65±1° C. for 1 hour.

The product is cooled and then partially neutralised by adding a 50% by mass aqueous solution of sodium hydroxide until pH 7.2 is reached. The aqueous polymeric solution comprises less than 43 ppm of residual dry acrylic acid with respect to the total amount of dry copolymer. A copolymer (P9) is obtained with a molecular mass by weight of 68,100 g/mol and a polymolecularity index P_{I} of 2.3.

### Example 1.10: Copolymer (P10) According to the Invention

Iron sulphate heptahydrate (0.11 g), a 60% by mass solution in water (318 g) of a monomer (b3) of formula (I) wherein R¹ represents CH₃, R² represents H, L represents CH₂, L² represents a combination (CH₂—CH₂O)ₓ, (CH₂CH(CH₃)O)_{y} and (CH(CH₃)CH₂O)_{z}, x represents 52 and y+z represents 11, with a molecular mass of 3,000 g/mol, and a 20% by mass solution in water (2.54 g) of DPTTC, are placed in a stirred reactor. The reactor is heated to 65±1° C.

Hydrogen peroxide is added in a 35% by mass aqueous solution (5.6 g).

Then, for 2 hours, a mixture of water (50 g) and of acrylic acid (20.14 g), a mixture of a 20% by mass solution of DPTTC (10.15 g) and of water (40 g) and a mixture of water (50 g) and of ammonium persuplhate (2.26 g) are simultaneously injected into the reactor.

The reactor is then kept at a temperature of 65±1° C. for 1 hour.

The product is cooled and then partially neutralised by adding a 50% by mass aqueous solution of sodium hydroxide until pH 7.5 is reached. The aqueous polymeric solution comprises less than 25 ppm of residual dry acrylic acid with respect to the total amount of dry copolymer.

A copolymer (P10) is obtained with a molecular mass by weight of 53,390 g/mol and a polydispersity index of 2.1.

### Example 1.11: Copolymer (P11) According to the Invention

Iron sulphate heptahydrate (0.11 g), a 60% by mass solution in water (318 g) of a monomer (b3) of formula (I) wherein R¹ represents CH₃, R² represents H, L represents CH₂, L² represents a combination (CH₂—CH₂O)ₓ, (CH₂CH(CH₃)O)_{y} and (CH(CH₃)CH₂O)_{z}, x represents 52 and y+z represents 11, with a molecular mass of 3,000 g/mol, and a 20% by mass solution in water (2.54 g) of DPTTC, are placed in a stirred reactor. The reactor is heated to 65 PC.

Hydrogen peroxide is added in a 35% by mass aqueous solution (5.6 g).

Then, for 1 hour, a mixture of water (50 g) and of acrylic acid (20.14 g), a mixture of a 20% by mass solution of DPTTC (10.15 g) and of water (40 g) and a mixture of water (50 g) and ammonium persuplhate (2.26 g) are simultaneously injected into the reactor.

The reactor is kept at a temperature of 65±1° C. for 1 hour.

The product is cooled and then partially neutralised by adding a 50% by mass aqueous solution of sodium hydroxide until pH 7 is reached. The aqueous polymeric solution comprises less than 10 ppm of residual dry acrylic acid with respect to the total amount of dry copolymer.

A copolymer (P11) is obtained with a molecular mass by weight of 56,460 g/mol and a polymolecularity index P₁ of 1.2.

### Example 1.12: Copolymer (P12) According to the Invention

Iron sulphate heptahydrate (0.088 g), a 60% by mass solution in water (362 g) of a monomer (b15) with a molecular mass of 2,400 g/mol, a 20% by mass solution in water (2.54 g) of DPTTC, and 50 g of water are placed in a stirred reactor. The reactor is heated to 65±1° C.

Hydrogen peroxide is added in a 35% by mass aqueous solution (5.6 g).

Then, for 1 hour, a mixture of water (40 g), of acrylic acid (31.17 g) and of methacrylic acid (7.8 g), a mixture of a 20% solution of DPTTC (8.12 g) and water (50 g), and a mixture of water (50 g) and of a 40% solution of sodium metabisulphite (4.51 g) are simultaneously injected into the reactor.

The reactor is then kept at a temperature of 65±1° C. for 1 hour.

The product is cooled and then partially neutralised by adding a 50% by mass aqueous solution of sodium hydroxide until pH 7.1 is reached. The aqueous polymeric solution comprises less than 667 ppm of residual dry acrylic acid with respect to the total amount of dry copolymer and 5 ppm of residual methacrylic acid with respect to the total amount of dry polymer.

A copolymer (P12) is obtained with a molecular mass by weight of 81,090 g/mol and a polymolecularity index P_{I} of 1.2.

### Example 1.13: Comparative Copolymer

Water (50 g), a 60% by mass solution in water (432.53 g) of monomer (b15) with a molecular mass of 2,400 g/mol and DMDO (1,8-dimercapto-3,6-dioxaoctane) (0.62 g) are placed in a stirred reactor. The reactor is heated to 37±2° C. Hydrogen peroxide is added in a 35% by mass aqueous solution (5.6 g).

Then, for 1 hour and 15 minutes, a mixture of water (30 g) and of acrylic acid (29.47 g), a mixture of water (25 g), a 60% by mass solution in water (32.7 g) of monomer (b15) with a molecular mass of 2,400 g/mol and DMDO (4.93 g) and a mixture of water (55 g) and a 40% by mass solution in water (5.64 g) of sodium bisulphite are simultaneously injected into the reactor, with this latter mixture injected in 1 hour and 40 minutes.

The reactor is kept at a temperature of 37±2° C. for 1 hour and 30 minutes.

The product is cooled and then partially neutralised by adding a 50% by mass aqueous solution of sodium hydroxide (32.5 g). The aqueous polymeric solution comprises more than 12,000 ppm of residual dry acrylic acid with respect to the total amount of dry copolymer. Moreover, nearly 60% by weight of monomer (b15) did not react.

### Example 1.14: Comparative Copolymer

Water (50 g), iron sulphate heptahydrate (0.11 g), a 60% by mass solution in water (264.56 g) of monomer (b15) with a molecular mass of 2,400 g/mol and DMDO (1,8-dimercapto-3,6-dioxaoctane) (0.62 g) are placed in a stirred reactor. The reactor is heated to 37±2° C. Hydrogen peroxide is added in a 35% by mass aqueous solution (5.6 g).

Then, for 1 hour and 15 minutes, a mixture of water (30 g) and of acrylic acid (32.49 g), a mixture of water (25 g), a 60% by mass solution in water (32.7 g) of monomer (b15) with a molecular mass of 2,400 g/mol and DMDO (4.93 g) and a mixture of water (55 g) and a 40% by mass solution in water of sodium bisulphite (5.64 g) are simultaneously injected into the reactor, with this latter mixture injected in 1 hour and 40 minutes.

The reactor is kept at a temperature of 37±2° C. for 1 hour and 30 minutes.

The product is cooled and then partially neutralised by adding a 50% by mass aqueous solution of sodium hydroxide (36.6 g). The aqueous polymeric solution comprises more than 12,000 ppm of residual dry acrylic acid with respect to the total amount of dry copolymer. Moreover, nearly 20% by weight of monomer (b15) did not react.

### Example 2: Assessment of Water-Reducing Properties in a Mortar

Mortar formulations, the composition of which is shown in Table 1, are prepared according to the following procedure:
incorporating the admixture and the water in the bowl of an automatic Perrier mixer for standardised cements and mortars,
incorporating all the fines (cement and/or hydraulic binders),
mixing at a slow speed of 140 rpm,
incorporating the sand after 30 seconds,
mixing at a slow speed of 140 rpm for 60 seconds,
pausing for 30 seconds and cleaning the sides of the bowl,
mixing at a slow speed of 140 rpm for 90 seconds.

Similarly, a comparative formulation (CF) of mortar is prepared comprising no copolymer.

The water-reducing properties of the copolymers according to the invention are assessed using the mortar formulations.

The T0 workability of the mortars formulated with the copolymers according to the invention was assessed by measuring the slump flow in accordance with standard EN 12350-2 adapted to mortar (Abrams mini-cone test).

To perform the slump flow test, the cone filled with formulated mortar is lifted perpendicular to a horizontal plate while rotating it one-quarter turn. The slump is measured with a ruler after 5 minutes across two 90° diameters. The result of the slump test is the average of the 2 values to ±/−1 mm. The tests are conducted at 20° C. The admixture content is determined such that a target slump of 220 mm±/−5 mm can be reached. The content is expressed in % by dry weight with respect to the weight of the hydraulic binder or the mixture of hydraulic binders. The results are shown in Table 1.

TABLE 1

| | | According to the | |
|---|---|---|---|
| | | invention | |
| Formulation | CF | F1-1 | F1-3 |
| AFNOR sand (g) | 1,350 | 1,350 | 1,350 |
| CEM I 52.5N VICAT cement (g) | 450 | 450 | 450 |
| Copolymer (% by dry weight/ | / | P2 (0.09) | P3 (0.10) |
| dry weight of cement) | | | |
| Anti-foaming agent (%/admixture) | / | 0.5 | 0.5 |
| Water (g) | 266 | 200 | 200 |
| Water/cement weight ratio | 0.59 | 0.44 | 0.44 |
| T0 workability | 220 | 220 | 220 |
| Water reduction (%) | 0 | 25 | 25 |

The use of the copolymers according to the invention makes it possible to reduce the amount of water in the hydraulic formulation by 25% while maintaining an initial slump level (workability) similar to that of the comparative formulation comprising no copolymer.

The copolymers according to the invention can therefore be qualified as highly water-reducing agents according to standard ADJUVANT NF EN 934-2. Indeed, they make it possible to reduce the water in the admixed mortar by at least 12% with respect to the control mortar.

### Example 3: assessment of water-reducing properties in Concrete

Concrete formulations (300 kg/m3) are prepared in accordance with standard NF EN 480-1 by mixing standardised sand (0/4), cement (CEM I 52.5N Vicat), 4/11 and 11/22 gravel, water and an anti-foaming agent in a mixer along with copolymer according to the invention. Similarly, a comparative concrete formulation is prepared comprising no copolymer. The proportions of each of the ingredients in the hydraulic formulations prepared are shown in Table 2.

The water/cement weight ratio is adjusted so as to preserve an initial workability similar to that of the comparative concrete formulation.

The hydraulic formulations have a uniform appearance, with no segregation of the ingredients.

The initial slump level (T0 workability) and the water reduction in the hydraulic formulations are shown in Table 2.

The initial slump level (or T0 workability) is tested at ambient temperature, using a bottomless, frustoconical cone made of galvanised steel, known as an Abrams cone, in accordance with standard EN 12350-2. This cone has the following characteristics:
upper diameter: 100±2 mm,
lower diameter: 200±2 mm and
height: 300±2 mm.

The cone is placed on a moistened horizontal plate and filled with a set amount of each of the formulations. Filling takes two minutes. The contents of the cone are tamped down with a metallic rod.

When the cone is full, it is lifted vertically, allowing its contents to slump onto the plate. The concrete formulations can be classified with respect to their workability in accordance with standard EN 206-1.

The amount of water reduction is measured in accordance with standard ADJUVANT NF EN 934-2. The results obtained for the various hydraulic formulations are shown in Table 2.

TABLE 2

| | | According to the | |
|---|---|---|---|
| | | invention | |
| Formulation | CF | F1-4 | F1-1 |
| Sand (kg) | 32.6 | 32.6 | 32.6 |
| 4/11 gravel (kg) | 12.4 | 12.4 | 12.4 |
| 11/22 gravel (kg) | 29.1 | 29.1 | 29.1 |
| Cement | 12 | 12 | 12 |
| Copolymer (% by dry weight/ | / | P1 (0.21) | P2 (0.23) |
| dry weight of cement) | | | |
| Anti-foaming agent (%/admixture) | / | 0.5 | 0.5 |
| Water (g) | 7,706 | 5,778 | 5,778 |
| Water/cement weight ratio | 0.64 | 0.48 | 0.48 |
| T0 workability | 220 | 220 | 225 |
| Water reduction (%) | 0 | 25 | 25 |

The use of the copolymers according to the invention makes it possible to reduce the amount of water in the hydraulic formulation by 25% while maintaining an initial slump level (workability) similar to that of the comparative hydraulic formulation.

The copolymers according to the invention can therefore be classed as highly water-reducing agents according to standard ADJUVANT NF EN 934-2. Indeed, they make it possible to reduce the water in the admixed concrete by at least 12% with respect to the control concrete.

1: An aqueous composition comprising at least one copolymer, the polymolecularity index P_{I} of which is less than 3, obtained by at least one radical polymerisation reaction in water and at a temperature ranging from 10 to 90° C.:
(a) of at least one anionic monomer comprising at least one polymerisable olefinic unsaturation and at least one carboxylic acid group and
(b) of at least one monomer of formula (I): 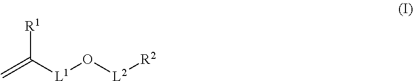
wherein:
R¹ and R², identical or different, independently represent H or CH₃,
L¹ independently represents a group selected from the group consisting of CH₂, CH₂—CH₂ and O—CH₂—CH₂—CH₂—CH₂,
L² independently represents a group selected from the group consisting of (CH₂—CH₂O)ₓ, (CH₂CH(CH₃)O)_{y}, (CH(CH₃)CH₂O)_{z} and combinations thereof and
x, y and z, identical or different, independently represent an integer or decimal between 0 and 150 and the sum of x+y+z is between 10 and 150,
in the presence:
(i) of from 0.05 to 5% by weight, with respect to the amount of monomers, of at least one compound of formula (II): 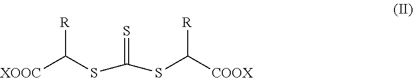
wherein:
X independently represents H, Na or K and
R independently represents a C₁-C₅ alkyl group and
(ii) of at least one radical-generating compound selected from the group consisting of hydrogen peroxide, ammonium persulphate, an alkali metal persulphate, and mixtures or associations thereof with ammonium bisulphite, with an alkali metal bisulphite or with an ion selected from the group consisting of Fe^{II}, Fe^{III}, Cu^{I}, Cu^{II}.

2: The composition according to claim 1, comprising no homopolymer of monomer (a) or comprising a reduced, small or very small amount by weight of homopolymer of monomer (a) with respect to the amount by dry weight of copolymer.

3: The composition according to claim 1, wherein the polymerisation reaction uses:
from 1 to 25% by weight of monomer (a) and
from 75 to 99% by weight of monomer (b).

4: The composition according to claim 1, wherein the copolymer comprises:
from 1 to 25% by weight of monomer (a) and
from 75 to 99% by weight of monomer (b).

5: The composition according to claim 1, comprising less than 2,000 ppm by weight of residual monomer (a) with respect to the amount by dry weight of copolymer.

6: The composition according to claim 1, wherein the monomer (a) used is selected from the group consisting of acrylic acid, methacrylic acid, itaconic acid, maleic acid, an acrylic acid salt, a methacrylic acid salt, an itaconic acid salt, a maleic acid salt and mixtures thereof.

7: The composition according to claim 1, wherein x is strictly greater than y+z.

8: The composition according to claim 1, wherein the radical polymerisation reaction in water is performed at a temperature ranging from 30 to 85° C.

9: The composition according to claim 1, wherein the polymerisation reaction also uses another anionic monomer.

10: The composition according to claim 1, wherein the polymerisation reaction also uses at least one other monomer (c) selected from the group consisting of:
another anionic monomer,
a non-ionic monomer comprising at least one polymerisable olefinic unsaturation,
2-acrylamido-2-methylpropanesulphonic acid, a salt of 2-acrylamido-2-methylpropanesulphonic acid, 2-(methacryloyloxy)ethanesulphonic acid, a salt of 2-(methacryloyloxy)ethanesulphonic acid, sodium methallyl sulphonate, styrene sulphonate and mixtures thereof.

11: A copolymer, the polymolecularity index P of which is less than 3, obtained by at least one radical polymerisation reaction in water and at a temperature ranging from 10 to 90° C.:
(a) of at least one anionic monomer comprising at least one polymerisable olefinic unsaturation and at least one carboxylic acid group and
(b) of at least one monomer of formula (I): 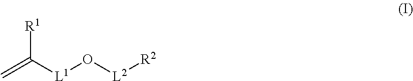
wherein:
R¹ and R², identical or different, independently represent H or CH₃,
L¹ independently represents a group selected from the group consisting of CH₂, CH₂—CH₂ and O—CH₂—CH₂—CH₂—CH₂,
L² independently represents a group selected from the group consisting of (CH₂—CH₂O)ₓ, (CH₂CH(CH₃)O)_{y}, (CH(CH₃)CH₂O)_{z} and combinations thereof and
x, y and z, identical or different, independently represent an integer or decimal between 0 and 150,
in the presence:
(i) of from 0.05 to 5% by weight, with respect to the amount of monomers, of at least one compound of formula (II): 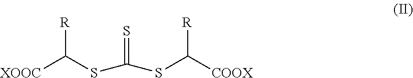
wherein:
X independently represents H, Na or K and
R independently represents a C₁-C₅ alkyl group and
(ii) of at least one radical-generating compound selected from the group consisting of hydrogen peroxide, ammonium persulphate, an alkali metal persulphate, and mixtures or associations thereof with ammonium bisulphite, with an alkali metal bisulphite or with an ion selected from the group consisting of Fe^{II}, Fe^{III}, Cu^{I}, Cu^{II}.

12: The copolymer according to claim 11, comprising:
from 1 to 25% by weight of monomer (a) and
from 75 to 99% by weight of monomer (b).

13: A formulation comprising:
at least one aqueous composition according to claim 1,
at least one hydraulic binder, optionally
water, optionally
at least one aggregate, optionally
at least one admixture.

14: The formulation according to claim 13, comprising:
from 0.01 to 5% by dry weight of copolymer, respectively in the form of the at least one aqueous composition, and
from 95 to 99.9% by dry weight of at least one hydraulic binder.

15: The formulation according to on claim 13, comprising water in an amount by weight, with respect to the amount by weight of the hydraulic binder, of less than 0.7.

16: A method for changing the rheology of a hydraulic formulation, comprising adding at least one aqueous composition according to claim 1 to the hydraulic formulation.

17: A method for controlling the workability of a hydraulic formulation, comprising adding at least one aqueous composition according to claim 1 to the hydraulic formulation.

18: The method for controlling workability according to claim 17, wherein the workability of the hydraulic formulation is kept constant for at least 1 hour.

19: A method for reducing the setting time of a hydraulic formulation, comprising adding at least one aqueous composition according to claim 1 to the hydraulic formulation.
